(19) United States
(12) Patent Application Publication
(10) Pub. No.: US 2016/0073577 A1
(43) Pub. Date: Mar. 17, 2016

(54) Method of Seed Bulking with Compost

(71) Applicant: Royal Organics, LLC, Richland, WA (US)

(72) Inventor: Thad Schutt, Richland, WA (US)

(21) Appl. No.: 14/855,085

(22) Filed: Sep. 15, 2015

Related U.S. Application Data
(60) Provisional application No. 62/050,662, filed on Sep. 15, 2014.

(51) Int. Cl. A01C 21/00; C05G 3/00; C05F 11/00

(52) U.S. Cl. CPC A01C 21/00; C05F 11/00; C05G 3/0005

(57) ABSTRACT

A method of adding a compost bulking agent to seed and applying the compost bulking agent/seed mixture to an area of soil is discussed herein. The disclosure describes determining an amount of seed for an area soil and adding an amount of compost bulking agent to the determined amount of seed. In some embodiments, the disclosure describes applying the compost bulking agent/seed mixture to an area of soil.

### PRIORITY

The present application claims priority to U.S. Provisional Application Ser. No. 62/050,662, filed on Sep. 15, 2014, entitled “Method of Seed Bulking with Compost,” the entirety of which, is incorporated by reference.

### BACKGROUND

Bulking agents may benefit seed planting for plant species that require a low volume of seeds (i.e., a low pound of seed per acre ratio). In some instances, the bulking agents, which generally cost less than the seeds, may optimize a resultant plant density allowing the crop to better fight diseases and/or reduce lodging. Ultimately, the result is a higher quality crop with an increased yield. However, traditional bulking agents may be limited to a particular benefit, require significant modifications based on the soil type/texture, and/or require significant modifications based on the type/quantity of seed being planted.

Therefore, there remains a need for a bulking agent that provides the traditional benefits (e.g., optimized plant density) while also requiring fewer modifications based on the soil and/or seed being planted.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A first embodiment concerns a method of applying a seed with a compost bulking agent. The method may include adding an amount of compost bulking agent to an amount of seed. In some embodiments, the mixture of seed and compost bulking agent may be mixed in a ratio from about one (1) pound of seed to about four (4) pounds of compost bulking agent to a ratio of about one (1) pound of seed to about twelve (12) pounds of compost bulking agent. In some embodiments, the mixture of seed and compost bulking agent may be mixed in a ratio from about one (1) pound of seed to about one and a half (1.5) pounds of compost bulking agent to a ratio of about one (1) pound of seed to about thirty-nine (39) pounds of compost bulking agent. In some embodiments, the compost bulking agent may be added to the seed in an amount of, from about from about 125% to about 1500% per weight of seed, from about 400% to about 1200% per weight of seed, or from about 200% to about 400%.

Another embodiment concerns a method of applying a seed/compost bulking agent mixture to soil. The method may include applying seed/compost bulking agent mixture to an area of soil at an amount of from about 40 pounds per acre of soil to about 100 pounds per acre of soil.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example environment with an example device for applying a compost bulking agent/seed mixture to soil.

FIG. 2 illustrates a flowchart illustrating an embodiment of a method of mixing a compost bulking agent with seed.

FIG. 3 illustrates a flowchart illustrating an embodiment of a method of applying a compost bulking agent/seed mixture to soil.

### DETAILED DESCRIPTION

### Overview

This disclosure describes, in part, methods of adding a compost bulking agent to seed. In some embodiments, the compost bulking agent may be added to the seed prior to planting the seed or “seeding”. In some embodiments, the compost bulking agent may be added to seed such that a substantially reduced amount of seed is needed to adequately plant an area. Traditionally, seeds that may be planted in low volumes (e.g., a seed volume of less than 10 pounds per acre), such as, but not limited to, canola, mustard, sunflowers, etc., may benefit from the use of bulking agents to provide better seed placement and distribution. In some instances, this is because most seed planting methods (e.g., conventional or no-till) require seed amounts of 40 pounds per acre or greater to accurately spread the seed. The result of adding a bulking agent may optimize seed placement and distribution which in turn may decrease resultant crop diseases and produce better crop yields.

Furthermore, traditional bulking agents may be used for an additional specific benefit apart from providing better seed placement and distribution. For instance, elemental sulfur or other soil amendments may be used as a bulking agent to alter the pH of the soil. However, the amount of sulfur to add to seed as a bulking agent is highly dependent on soil texture and/or the needs of the seed being planted. In addition, it is generally useful to apply and incorporate sulfur into the soil at least a year before planting to allow the sulfur time to react and alter the soil pH before planting. Thus, traditionally a user must carefully select the quantity of bulking agent based on the soil type/texture, type of seed being planted, and/or time of application of the bulking agent in order for the bulking agent to provide the specific additional benefit.

As described herein, a compost bulking agent may be added to seed to provide better seed placement and distribution. In some embodiments, the compost bulking agent may be a solid pelletized compost which may include but is not limited to yard waste (grass trimmings, leaves, prunings, etc.), food waste, wood waste, agricultural residues (mint, cull fruit, cull hop residue, grape pumice, etc.), manures, biosolids (e.g., an organic product of a wastewater treatment process), and so forth. In some embodiments, the compost bulking agent may comprise from about 15% to about 45% of mint or from about 25% to about 35% of mint. According to certain embodiments, the compost bulking agent described herein may comprise at least 5%, 10%, 15%, 20%, 25%, 30%, 35%, 40%, 45%, 50% of mint. As described below, in some embodiments, the compost bulking agent may be added to seed in any ratio such that a seeder may accurately spread a low volume of seed. Furthermore, the compost bulking agent/seed mixture may provide several benefits to the resultant crop and/or user.

For instance, the compost bulking agent may cost substantially less than other bulking agents and/or seeds. The compost bulking agents described herein are organic and non-chemical. Moreover, because the composts described herein are organic in nature, the composts may resist runoff thereby greatly reducing the amount of material that leaches into waterways. The methods described herein may allow for a substantially reduced amount of fertilizer(s) to be used while resulting in substantially the same or improved crop yield over traditional seeding methods. According to certain embodiment, the methods described herein provide a crop yield that is at least 5%, 10%, 15%, 20%, 25%, 30%, 35%, 40%, 45%, 50% or greater than crop yields seeding with traditional bulking agents.

As mentioned above, in some embodiments, the compost may be a solid. Moreover, when solid, the compost may be in the form of a pellet. When in pelletized form, the pellets may be made via any known method. For example, the pellets may be made by charging a thick liquid of paste form of the compost into a hopper of an extruder. The paste may then be extruded through a number of openings and cut to the desired size. The pellets may then be dried to a moisture content of less than about 15 weight percent. Care should be taken when drying so as not harm beneficial microbes in the pellets.

According to an embodiment, the compost bulking agent may be added to the seed in an amount of from about from about 125% to about 1500% per weight of seed, from about 400% to about 1200% per weight of seed, or from about 200% to about 400%. In some embodiments, the seed and compost bulking agent may be mixed in a ratio from about one (1) pound of seed to about four (4) pounds of compost bulking agent to a ratio of about one (1) pound of seed to about twelve (12) pounds of compost bulking agent. In some embodiments, the mixture of seed and compost bulking agent may be mixed in a ratio from about one (1) pound of seed to about one and a half (1.5) pounds of compost bulking agent to a ratio of about one (1) pound of seed to about thirty-nine (39) pounds of compost bulking agent. Exemplary low volume seeds (e.g. a seed volume of less than 10 lbs per acre) may include, but are not limited to, canola, rapeseed, safflower, camelina, crambe, cotton, mustard, and sunflower. In some embodiments, seed may include vegetable seed (e.g., carrot seed, lettuce seed, etc). However, it is to be understood that the described methods are not limited to low volume seed. In some embodiments, the method of using the compost described herein as a bulking agent may be implemented with other seed, such as, but not limited to wheat, barley, corn, rye, soybeans, hay, sorghum, rice, etc.

According to certain embodiments, the starting materials which may be biologically decomposed to form the compost bulking agent may include but are not limited to yard waste (grass trimmings, leaves, prunings, etc.), food waste, wood waste, agricultural residues (mint, cull fruit, cull hop residue, grape pumice, etc.), manures, Biosolids, etc.

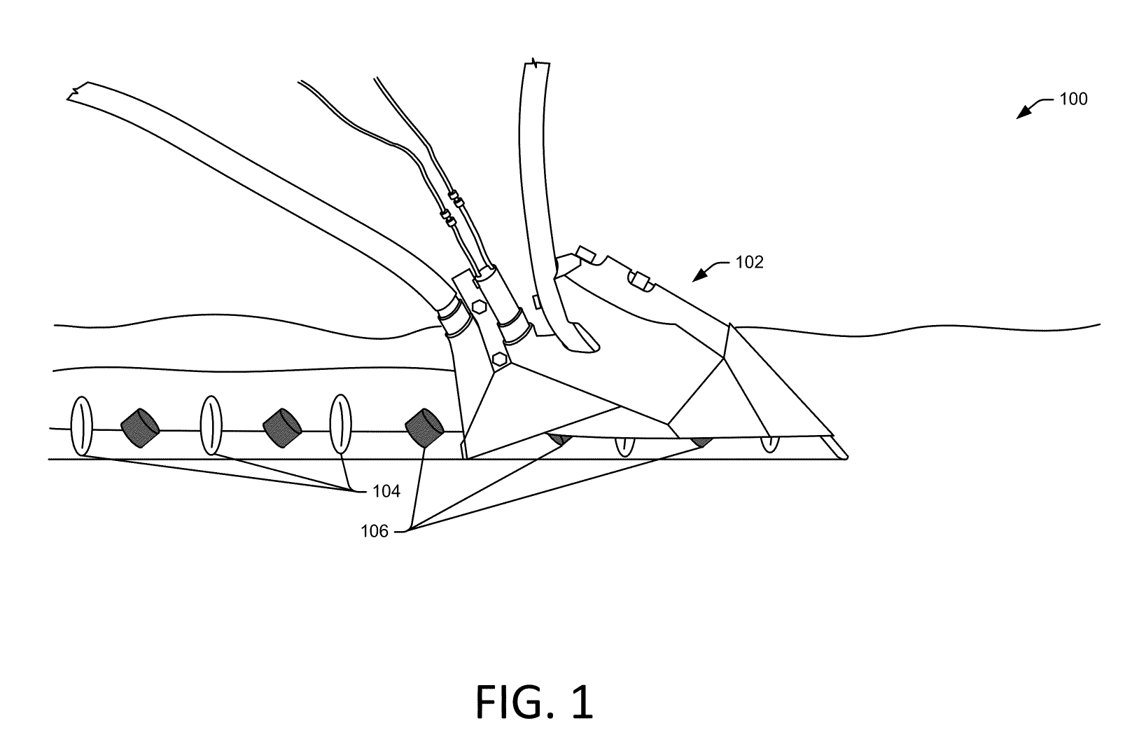

FIG. 1. illustrates an example environment 100 for applying a compost bulking agent/seed mixture to soil. As illustrated, environment 100 includes seeding equipment 102 which may place the compost bulking agent/seed mixture on top and/or within the soil. As shown, seeding equipment 102 may uniformly distribute the compost bulking agent/seed mixture such that the compost bulking agent and each seed is distributed in a particular pattern. However, in other embodiments, the seeding equipment 102 may randomly distribute the compost bulking agent/seed mixture to the soil. Environment 100 merely illustrates an example of seeding equipment. In other embodiments, other seeding equipment may be used to distribute the compost bulking agent/seed mixture. For instance, a seed drill, an air seeder, a broadcast spreader or a drop spreader may be used to distribute the compost bulking agent/seed mixture to the soil.

In some embodiments, a user may use a singulating planter in order to drop a single seed in a predetermined location rather than dropping multiple seeds at the location. The desired result of a distance between each single seed of this singulating type planting may yield resulting plants that a spaced at a distance known to increase plant spacing efficiency (e.g., 4-19 plants per square foot) and produce a higher crop yields. In many cases, the size of low volume seed is smaller than high volume seeds. For instance, a canola seed is smaller than a wheat seed. Furthermore, the singulating planters may have a difficult time placing a single seed of the smaller low volume seed types. As such, a user may use the compost bulking agent to bulk the low volume seed in the singulating planters in order for the user to plant the small, low volume seed at a desired pounds per acre (e.g., 40 pounds per acre).

According to certain embodiments, a chemical fertilizer, a mineral fertilizer, a soil amendment, another compost agent or a mixture thereof may be added to the soil before, after or while the compost bulking agent/seed mixture is being added to the soil. In some embodiments, where a fertilizer (solid and/or liquid) is applied in addition to the compost bulking agent/seed mixture, the fertilizer may be added in amount that is about ⅓ to ½ times less than the amount of fertilizer that would be added if the fertilizer was added to the soil without the application of the compost bulking agent while resulting in at least the same crop growth or yield. According to certain embodiments, applying a combination of the compost bulking agent and a substantially reduced amount of fertilizer results in a crop yield that is at least 0%, 5%, 10%, 15%, 20% or greater than if the fertilizer was applied without the compost bulking agent.

As used herein the term “compost” or “compost bulking agent” is meant to include any variety of organic material, which may be animal or vegetable in origin, and which through biological, such as microbial (bacterial, fungal, and actinomycetes) action under controlled conditions to promote aerobic decomposition. The organic material may be modified or converted to stable compost material for agricultural purposes.

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” “contain,” “including,” “includes,” “include,” and “have” have the same open-ended meaning as “comprising,” “comprises,” and “comprise” provided above.

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds) and provided literal support for and includes the end points of 10 and 100.

The present description uses specific numerical values to quantify certain parameters relating to the invention, where the specific numerical values are not expressly part of a numerical range. It should be understood that each specific numerical value provided herein is to be construed as providing literal support for a broad, intermediate, and narrow range. The broad range associated with each specific numerical value is the numerical value plus and minus 60 percent of the numerical value, rounded to two significant digits. The intermediate range associated with each specific numerical value is the numerical value plus and minus 30 percent of the numerical value, rounded to two significant digits. The narrow range associated with each specific numerical value is the numerical value plus and minus 15 percent of the numerical value, rounded to two significant digits. These broad, intermediate, and narrow numerical ranges should be applied not only to the specific values, but should also be applied to differences between these specific values.

The method of adding a compost bulking agent to seed may be implemented in a number of ways. Example implementations are provided below with reference to the following figures.

### Illustrative Processes

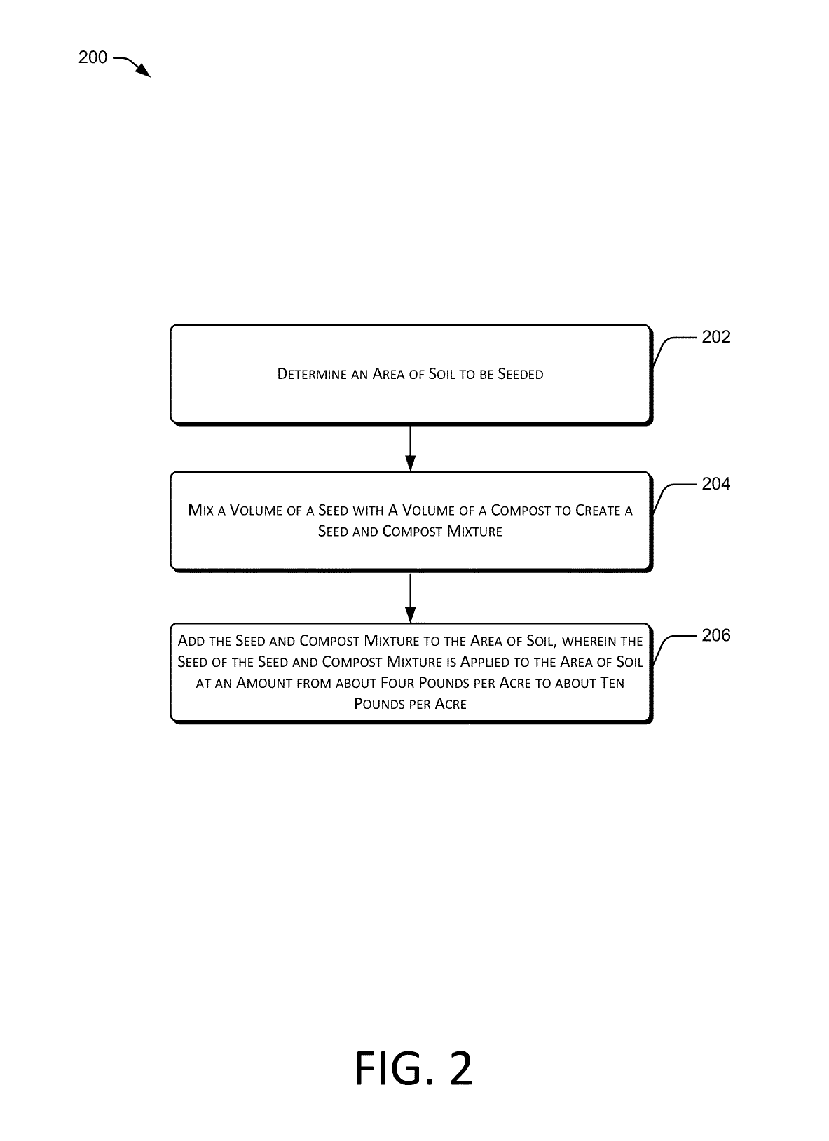

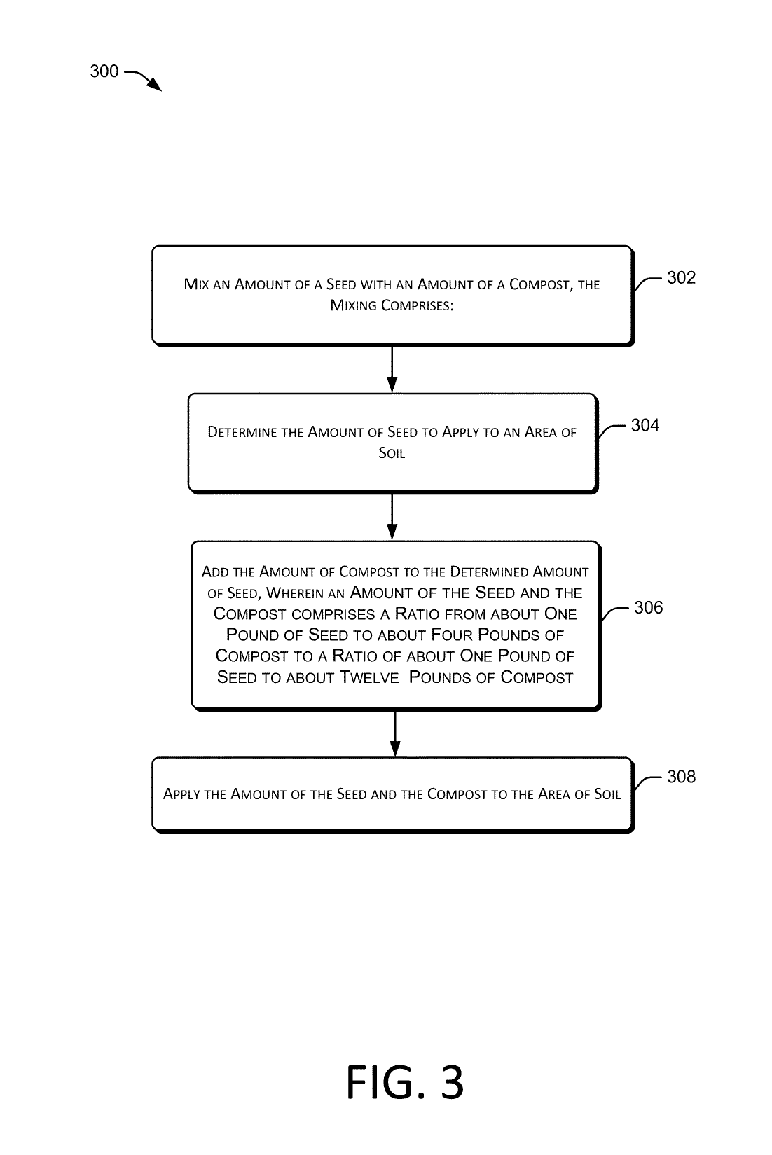

FIGS. 2 and 3 are flow diagrams of illustrative processes 200 and 300, respectively, for implementing the techniques described above of adding a compost bulking agent to a low-volume seed and adding the compost bulking agent/seed mixture to soil. These processes are illustrated as a collection of blocks in a logical flow graph. The order in which the operations are described is not intended to be construed as a limitation, and any number of the described blocks can be combined in any order and/or in parallel to implement the processes.

At 202, an area of soil to be seed may be determined. For instance, a user may determine that they would like to seed ten acres of soil with a particular seed such as canola seed. At 204, a volume of a seed may be mixed with a volume of a compost to create a seed and compost mixture. For instance, a user may mix an amount of seed needed to plant the determined area of soil with compost. In some embodiments, the compost may be added to the seed in a ratio from about one pound of seed to about four pounds of compost to a ratio of about one pound of seed to about twelve pounds of compost. In some embodiments, the mixture of seed and compost bulking agent may be mixed in a ratio from about one (1) pound of seed to about one and a half (1.5) pounds of compost bulking agent to a ratio of about one (1) pound of seed to about thirty-nine (39) pounds of compost bulking agent. At 206, the seed and compost mixture may be added to the area of soil, wherein the seed and compost mixture may be applied to the area of soil at an amount from about one pounds per acre to about fifteen pounds per acre, or from about four pounds per acre to about ten pounds per acre.

FIG. 3 illustrates techniques described above of adding a compost bulking agent/seed mixture to soil. For instance, at 302, an amount of a seed may be mixed with an amount of compost. The mixing may comprise determining an amount of seed to apply to an area of soil at 304. In some embodiments, the amount may be a mass or a volume measured in pounds per acre. The mixing may continue at 306, where an amount of compost may be added to the determined amount of seed and the amount of seed and the amount of compost comprise a ratio from about one pound of seed to about four pounds of compost to a ration of about one pound of seed to about twelve pounds of compost.

At 308, the amount of seed and the compost may be applied to the area of soil. In some implementations, an amount of seed/compost bulking agent mixture may be applied to an area of soil at an amount of from about 40 pounds per acres to about 100 pounds per acre of soil.

### EXAMPLE

Five pounds of canola seed, per acre, were mixed with 40 lbs, of compost pellet bulking agent. The mixture was planted using a planter. The result was uniform planting with better singulation of the seed compared to planting seed without the compost pellet bulking agent. Less seed was applied per acre to obtain the same amount of coverage due to the uniform planting. The germination rate remained the same.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of seeding soil comprising:
determining an area of soil to be seeded; and
mixing a volume of a seed with a volume of a compost to create a seed and compost mixture; and
adding the seed and compost mixture to the area of soil, wherein the seed of the seed and compost mixture is applied to the area of soil at an amount from about one (1) pound per acres to about fifteen (15) pounds per acre.

2. The method as recited in claim 1, wherein the volume of the seed and the volume of the compost are mixed in a ratio from about one (1) pound of seed to about four (4) pounds of compost to a ratio of about one (1) pound of seed to about twelve (12) pounds of compost.

3. The method as recited in claim 1, wherein a total volume of the seed and compost mixture comprises at least 40 pounds per acre.

4. The method as recited in claim 1, wherein the compost is added at an amount of from about 125% to about 1500% per weight of seed.

5. The method as recited in claim 5, wherein the compost is added at an amount of from about 400% to about 1200% per weight of seed.

6. The method as recited in claim 1, wherein another compost is added to the soil before, during or after seeding.

7. The method as recited in claim 1, wherein a chemical fertilizer, a mineral fertilizer, a soil amendment, another compost or a mixture thereof is added to the soil.

8. The method as recited in claim 1, wherein the compost comprises pelletized compost.

9. The method as recited in claim 8, wherein the compost comprises mint.

10. A method of seeding with a compost bulking agent comprising:
mixing an amount of a seed with an amount of a compost, the mixing comprises:
determining the amount of seed to apply to an area of soil;
adding the amount of compost to the determined amount of seed, wherein an amount of the seed and the compost comprises a ratio from about one (1) pound of seed to about four (4) pounds of compost to a ratio of about one (1) pound of seed to about twelve (12) pounds of compost; and
applying the amount of the seed and the compost to the area of soil.

11. The method as recited in claim 10, wherein the amount of seed comprises less than 10 pounds per acre.

12. The method as recited in claim 10, wherein the seed comprises at least one of canola seed, rapeseed seed, safflower seed, camelina seed, crambe seed, cotton seed, mustard seed, or sunflower seed.

13. The method as recited in claim 10, wherein the amount of the seed and the compost is added to the area of soil at an amount of from about 30 to about 75 lbs per acre of soil.

14. The method as recited in claim 13, wherein the amount of the seed and the compost pellets are added to the area of soil at an amount of from about 40 to about 50 lbs per acre of soil.

15. The method as recited in claim 10, wherein an additional compost pellet are added to the soil before, during or after seeding.

16. The method as recited in claim 10, wherein a chemical fertilizer, a mineral fertilizer, a soil amendment, another compost pellet or a mixture thereof is added to the soil.

17. The method as recited in claim 10, wherein the compost comprises pelletized compost.

18. The method as recited in claim 17, wherein the pelletized compost comprises from about 25% to about 35% mint.
